(19) United States
(12) Patent Application Publication
(10) Pub. No.: US 2007/0035856 A1
(43) Pub. Date: Feb. 15, 2007

(54) Multi-axis positioner

(76) Inventors: John Galpin, Isle of Man (GB); Philip Gurner, Isle of Man (GB); Gordon Chapman, Cambridge (GB); Jim Coates, Cambridgeshire (GB); Terence Herbert, Herts (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/474,155

(22) Filed: Jun. 22, 2006

Related U.S. Application Data
(63) Continuation of application No. 10/543,501.

(30) Foreign Application Priority Data
Jan. 28, 2003 (GB) 0301937.9

(51) Int. Cl. G02B 7/02

(52) U.S. Cl. 359/819

(57) ABSTRACT

A multi-axis positioner comprising: a fixed part (40) having drive mounts (42, 44, 46) for receiving a plurality of drive inputs and a movable part (30) having surfaces for attaching a sample, wherein multiple drive trains, one for each of up to six motion axes, connect the drive inputs to the movable part. The whole device has a cuboid shape with the movable part fitting inside one corner. All the motion axes are driven by access through the two internally facing sides of the movable part, leaving all other sides free for sample mounting and/or external access. The whole device can be mounted in any orientation, e.g. on its side or upside down. It has flat mounting surfaces on each side, on the top and bottom and on the front. Only the rear is not available for mounting, since it is reserved as a drive input face for receiving the micrometer, or other, drives.

### BACKGROUND OF THE INVENTION

The invention relates to multi-axis positioners, such as three-axis positioners that provide x, y and z adjustment and six-axis positioners with x, y, z, roll, pitch and yaw adjustment.

FIG. 1 illustrates the principles of operation of a prior art device as described in EP-A-0937961[1] in which a movable block is manipulated by three pairs of linkages to provide up to six axes of motion. Products following this design are marketed by Melles Griot.

A movable block 7 is shown supported in space by three pairs of linkages 8, 2 and 3 via which the block 7 is moved in use. The three pairs of linkages are arranged to extend along mutually orthogonal axes x, y and z respectively. The linkages of each pair extend parallel to each other, so that each pair of linkages lies in a plane, this plane being perpendicular to the equivalent two planes in which the other two pairs of linkages lie.

FIGS. 2A and 2B show one of the linkages in side view, wherein the linkage of FIG. 2A is in an unstrained condition and the linkage of FIG. 2B is in a strained condition (illustrated to a highly exaggerated degree for clarity). The linkage is rigid in respect of forces applied along an axis of extent of the linkage referred to as lengthways in the following, but deformable in respect of forces applied across that axis of extent, referred to as sideways in the following. Consequently, a force applied to one end portion of the linkage substantially lengthways will be transmitted to the other end portion of the linkage, whereas a force applied to one end portion of the linkage sideways will not be transmitted to the other end of the linkage, but rather accommodated by lateral deformation of the linkage. The linkage comprises two end portions 18 and 19 disposed on either side of a central portion 20, the central and end portions being interconnected by two flexible portions 21 and 22. The central and end portions 18 to 20 are made of sections of stainless steel rod of 3 mm diameter. The central portion is around 25 mm in length and the end portions 10 mm. The flexible portions 21 and 22 are made of sections of music wire of 1 mm diameter and are each around 15 mm in free length with around 10 mm at each end received in bores in the central and end portions and cemented in place by adhesive bonding, thus to leave a free length of the wire sections.

Music wire is chosen because it allows a large degree of elastic bending and torsion without reaching the elastic limit, i.e. yield stress. To increase the maximum drive force and deformation angle that the linkages can withstand, flexible stiffening sleeves 23, 24 made of helical springs are fitted between each of the end portions 18, 19 and the central portion 20. This allows the linkage to be loaded up to the point at which the music wire buckles. Without the stiffening sleeve there is a lower drive force threshold and angular deformation threshold dictated by yield of the wire. These linkages can accommodate the ±2° of rotational motion in each of the rotational motion axes (roll, pitch, yaw).

Referring back to FIG. 1, the manner in which the movable block is manipulated is summarised. By moving any one of the pairs of linkages 2, 8 and 3 in unison, the block is pushed in a linear fashion along x, y or z to provide actuation of the x, y and z motion axes respectively, as labelled in the figure. To provide actuation of the rotational motion axes of yaw, pitch or roll, one linkage of each pair (2, 8 and 3 respectively) is moved relative to the other to rotate the movable block 7, as labelled in the figure.

FIG. 3 shows the mechanism by which one of the parallel pairs of linkages is driven in the 6-axis version of the prior art device to provide linear and rotational motion, for example y and pitch.

Two actuators 14 and 15, shown as micrometers, act on a pivotally mounted plate 1. The plate 1 is pivoted about a point B. The first micrometer 14 serves to impart a linear motion to the movable block 7. It acts at a point L such that a line LB, defined by points L and B, is perpendicular to the plane in which the two linkages 8 lie. The second micrometer 15 serves to impart a rotary motion to the movable block 7. It acts at a point R such that a line RB, defined by the points R and B, is parallel to the plane in which the two linkages 8 lie. Thus, when the micrometer 14 is actuated, the plate 1 hinges about the line RB and causes both of the linkages 8 of the pair to move together, resulting in linear movement of the block 7. When the micrometer 15 is actuated, the plate 1 hinges about the line LB and causes relative movement between the two linkages 8 of the pair, resulting in rotary movement of the block 7.

When three pivot plate mechanisms of the kind shown in the figure are used, a six-axis positioner can be provided, allowing movement of the block 7 in three linear directions x, y, & z and three rotary directions yaw, roll & pitch. For practical reasons, it is noted that the z/roll drive trains incorporate a 90° bend to allow the z and roll actuators to be horizontally mounted. Otherwise the z and roll actuators would be on the base of the device which would clearly be impractical for benchtop use.

If only rotary movement is required, the pivot plate can be substituted with a hinged plate hinged about the line LB and the actuator 14 dispensed with. Similarly, if only linear movement is required, a hinge plate hinged about the line RB can be used and the actuator 15 dispensed with.

FIGS. 4 and 5 are plan and side views of the real 6-axis device. FIG. 4 is a view along the z axis and FIG. 5 a view along the x-axis. Each of the six motion axes is driven by a single actuator, illustrated as a micrometer drive in each case. The x and yaw actuators extend from one of the x side faces of the device and have direct drive trains through to the movable block 7, similar to the schematic illustration of FIG. 3. The pitch actuator is also mounted on the same x side face as the x and yaw actuators, but has a drive train that undergoes a 90 degree bend to align with the y drive train which is a direct one driven from one of the y faces. The z and roll actuators are mounted on the same y face as the y actuator. The z and roll drive trains both have 90 degree bends to provide the necessary upward actuation on the movable block. The 90 degree bends are implemented with hinged intermediate blocks acted upon by ball-ended rods (not shown). The movable part 7 is finished on its upper surface as a sample mounting platform including mounting holes. A common point P is also illustrated. This is a single point above the movable part 7 about which all three rotary motion axes revolve. The device is mounted to an optical table or other workstation by a base plate 9. A housing 10 is connected to the base plate 9, also forming a fixed part of the device, and provides mounting for the pivot plates and actuators.

The prior art device has been a hugely successful product, but nevertheless has some shortcomings.

As is evident from FIG. 4, the footprint of the device is rather large, especially when the actuators are considered. The 3-axis version of the product providing only linear motion axes can be made considerably smaller because of the simpler drive train design, but is obviously more limited in its applications than the 6-axis version. Footprint is an important issue for applications in which it is desired to manipulate two or more items close together. This situation arises when two items are to be bonded or otherwise joined and need to be independently manipulated. This situation also arises when multiple optical components along a beam line need to be independently manipulated, since the footprint of the positioner may be the limiting factor in determining the minimum possible separation between adjacent optical components. The footprint demands are of course not specific to the prior art device described, but are generally applicable to any multi-axis positioner.

A further problem with the prior art device described, which is also a general problem for multi-axis positioners, is the “spaghetti” factor relating to routing of control cables. Actuators will be motor driven in any automated system, so that each actuator will have its own drive cables. These need to be routed in an acceptable fashion to a control unit. Usually the device will be mounted on an optical table further constraining routing options. While merely an inconvenience in a research laboratory, cable routing can be very important in a production environment. Health and safety factors are more important. Moreover, if automated robotic arms are part of the system, e.g. to pick and place components onto the positioner, cable location must be strictly defined to avoid snagging.

Another significant limitation of the device lies in the linkages. While the linkages provide a unique solution to provide the necessary degrees of freedom to allow any one of the drive trains to accommodate motion in the other drive trains, this flexibility is also a limitation. One important specification of any positioner is the maximum load it can push (and pull). In the case of the prior art device, the maximum load is quite modest, being limited by the load capacity of the music wires in the linkages which will yield or buckle if overloaded.

### SUMMARY OF THE INVENTION

The invention is based on a multi-axis positioner comprising:

(a) a fixed part having drive mounts for receiving a plurality of drive inputs;

(b) a movable part having a surface for attaching a sample to be positioned; and

(c) a plurality of drive trains connected between the drive inputs of the fixed part and the movable part, the drive trains being configured to move the movable part relative to the fixed part in a plurality of motion axes responsive to the drive inputs.

According to a first aspect of the invention, the positioner is characterised in that the fixed part has a plurality of mounting faces at least two of which are orthogonal to each other to allow the movable part to be arranged in different orientations. The provision of a plurality of orthogonal mounting faces allows the movable part to be arranged in different orientations so that the movable part need not be arranged upright, but can be arranged on its side, upside down, on its back or in any other orientation. This is quite different from a conventional positioner which can only be mounted and operated to specification in one particular orientation. Preferably, the positioner is provided with at least three orthogonal mounting faces. It is also preferable that there are one or two pairs of the mounting faces that are parallel to each other and face in opposite directions. It is advantageous if the fixed part has a further face on which all the drive inputs are arranged. The drive input face may be parallel to, and face in an opposite direction to, one of the mounting faces. The drive input face can be provided with an access aperture for each of the drive trains. Alternatively, to limit the number of drive trains that are active, the drive input face can be provided with a reduced set of access apertures, namely access apertures for only a subset of the drive trains to limit drive inputs to that subset of the drive trains. A piezo drive block may be attached to the drive input face if fine motion control using piezos is desired. A micrometer drive mounting block can also be attached to the drive input face, either directly or indirectly via the piezo drive block. The positioner can also be provided with at least one through hole running from one of the mounting faces through the positioner to allow passage of clamping bolts.

The mounting faces can conveniently be made integral with a movable part component. Moreover, it will be understood that the mounting faces can be used to mount a wide variety of devices, such as optical components, cameras, lamps (e.g. UV lamps), glue dispensers etc.

According to a second aspect of the invention, the positioner is characterised in that the movable part is confined to fit within a corner portion of a cuboid defined by six planes which coincide with at least some of the mounting faces, so that the movable part has four sides facing externally and two sides facing internally, wherein the drive trains access the movable part from the two internally facing sides only. This leaves the four externally facing sides free for utilisation for sample mounting and access, e.g. by manipulators. Six motion axes can be provided by actuation of the movable part from only the two internally facing sides. The movable part is preferably provided with four sample attachment surfaces aligned with the four externally facing sides of the movable part. Advantageously, the movable part is L-shaped in cross-section to provide an additional two externally facing sample attachment surfaces that extend parallel to the internally facing sides. Moreover, as well as all six drive trains actuating the moving world end through only two sides, all six drive trains are preferably actuated on the fixed world end from a single drive input face, as already mentioned in relation to the first aspect of the invention. This is of major significance, since it allows the orientation freedom of the device by providing that all the micrometer or other drives and their cabling (where required) emerge from one side of the device, preferably confined within the device cross-section, thereby allowing mounting on a flat surface using the top, bottom or either side as the mounting face. The front face may also be used.

It will be understood that the features of the first and second aspects of the invention are advantageously used in combination.

According to a third aspect of the invention, at least some of the positioner's drive trains include linkages which each comprises a rod connected at either end to an end part, each end part being connected to the rod by a joint, wherein the joints allow the linkages to accommodate movement of the other drive trains, wherein the joints are held under compression by resilient biasing elements. These may form part of the linkage and be connected under tension between the end part and its adjacent rod. Resilient biasing elements may also be provided that are separate from the linkages. For example, they can be secured at each end to the fixed parts of the positioner, or at one end to the fixed part and the other end to the movable part. Preferably both types of resilient biasing elements are provided, i.e. some formed as part of the linkages (termed as internal in the following) and some separate from the linkages (termed as external in the following). This design of linkage allows drive trains to be built that can cope with a very wide range of possible loads, thereby allowing the device to satisfy a stringent specification in terms of positioning accuracy for all possible mounting orientations. The joints are thus held under self-compression by the bracing of the internal springs or other internal resilient biasing elements, analogous to how the human knee joint is held together by its ligaments and/or under compression by the external springs or other external resilient biasing elements. The joints between the rods and end parts can be formed by a pin located on a surface and held under compression. Conveniently, the surface is conical to locate the pin at the base of the cone. Alternatively, the joints between the rods and end parts can be formed by a ball seated in a socket. These types of joint are capable of withstanding the high compression forces that result from the sum of the compression force from the springs and any compression force that results from loads during use. Typically, the compression has a force in the range 1 kgf to 20 kgf, or 2 to 11 kgf so that the linkages are capable of withstanding tension forces exerted along the linkage up to the compression force. In a preferred embodiment, the resilient biasing elements formed as part of the linkages are helical springs and the end parts are provided with a threaded portion having a pitch matched to the pitch of the coils of the helical spring, the end parts being connected to the helical spring by threaded engagement of the threaded portions in the spring coils. The threaded portion on the end part can be a male thread that is threaded into the inside of the helical spring, or a female thread that is threaded onto the outside of the helical spring. The rods can be provided with a threaded portion having a pitch matched to the pitch of the coils of the helical spring, the rods being connected to the helical spring by threaded engagement of the threaded portions in the spring coils. The threaded portion on the rod can be a male thread that is threaded into the inside of the helical spring, or a female thread that is threaded onto the outside of the helical spring. Moreover, the threaded portions on the rods can be formed by further helical springs fitted over the rod, or by conventional threads machined in the rods. It will be understood that the jointed, self-compression linkages using internal resilient biasing elements are standalone components that can be used in a wide variety of scenarios. It is envisaged that they be used in the drive trains of positioners, but other uses are also possible. The use of resilient biasing elements that are part of the linkages is very convenient for assembly, since each linkage can be assembled on its own as a sub-assembly before assembly of the rest of the positioner.

According to a fourth aspect of the invention, at least some of the positioner's drive trains include mutually contacting crossed pairs of spigots that can slide and rotate on each other to accommodate movement of the other drive trains. Preferably, the crossed pairs of spigots are arcuate in cross-section or some other cross-section that provides for that the crossed pairs of spigots contact each other tangentially. The crossed pairs of spigots can be maintained in contact with each other by a resilient biasing element arranged to exert a pulling force on one of the spigots towards the other.

It will be understood that the crossed pairs of spigots according to the fourth aspect of the invention can be used in a single drive train combined with the linkages of the third aspect of the invention. Moreover, the crossed pairs of spigots are advantageously used in combination with a flexure to constrain motion of the movable part induced by actuation of the drive train to the motion axis concerned. Furthermore, the crossed pairs of spigots are advantageously used in combination with a crank, such as a bell crank, to which one of a crossed pair of spigots is attached to redirect the drive train through 90 degrees or other angular amounts.

Finally, it will be understood that the design features of the first and/or second aspect of the invention, which relate principally to the external form of the positioner, are advantageously implementable in combination with internal design of the positioner's drive trains using the features of the third and/or fourth aspects of the invention.

### BRIEF DESCRIPTION OF THE DRAWINGS

For a better understanding of the invention and to show how the same may be carried into effect reference is now made by way of example to the accompanying drawings in which:

FIG. 1 illustrates the principles of operation of a prior art device as described in EP-A-0937961 in which a movable block is manipulated by three pairs of linkages to provide up to six axes of motion;

FIG. 2A shows one of the linkages of FIG. 1 in an unstrained state;

FIG. 2B shows one of the linkages in an extreme deformed state;

FIG. 3 shows schematically how one of the parallel pairs of linkages is driven in the 6-axis version of the prior art device;

FIG. 4 is a plan view of the 6-axis device along the z axis;

FIG. 5 is a side view of the 6-axis device along the x-axis;

FIG. 6 is a perspective view of a device embodying the invention;

FIG. 7 is a perspective view of the device of FIG. 6 with its drive interfaces removed;

FIG. 8 is a perspective view of the device of FIG. 6 with the side and top covers and letterbox housing removed to reveal internal structure;

FIG. 9 is a perspective view of the fixed world parts of the device of FIG. 6;

FIG. 10 is a perspective view of the moving world of the device of FIG. 6 together with the drive pins that directly contact it;

FIG. 11 is an exploded view of one of the drive pins;

FIG. 12 is a perspective view showing the principal components of the x drive train;

FIG. 13 is a perspective view showing the principal components of the yaw drive train;

FIG. 14 is a perspective view showing the principal components of the y drive train;

FIG. 15A is a highly schematic plan view showing the principles of the y drive train;

FIG. 15B shows the role of the crossed pins of the y drive train and how they move to accommodate motion of the other axes;

FIG. 16 is a perspective view showing the principal components of the roll drive train;

FIG. 17 is a perspective view showing the principal components of the z drive train;

FIG. 18A is a schematic side view showing the principal components of the z drive train;

FIG. 18B shows the role of the crossed pins of the z drive train and how they move to accommodate motion of the other axes;

FIG. 19 is a perspective view showing the principal components of the pitch drive train;

FIG. 20 is a schematic perspective view summarising the principles of operation of the device embodying the invention which is to be compared with the prior art FIG. 1;

FIG. 21 shows four devices arranged upright in a cross according to a first applications example;

FIG. 22 shows four devices arranged on their sides in a square according to a second applications example;

FIG. 23 shows four devices arranged on their sides in a square with mini breadboards on their upper surfaces according to a third applications example;

FIG. 24 shows two devices arranged with one inverted on top of the other according to a fourth applications example;

FIG. 25 shows two devices ganged together side-by-side and arranged on their backs and recessed in a breadboard according to a fifth applications example;

FIG. 26 shows three devices ganged together side-by-side separated by spacers and arranged upright on a breadboard according to a sixth applications example;

FIG. 27 shows four devices ganged together side-by-side and arranged upright on a breadboard according to a seventh applications example; and

FIG. 28 is a schematic system drawing showing a device according to the invention integrated with a control system and typical components of an automated system employing a device according to the invention.

### DETAILED DESCRIPTION

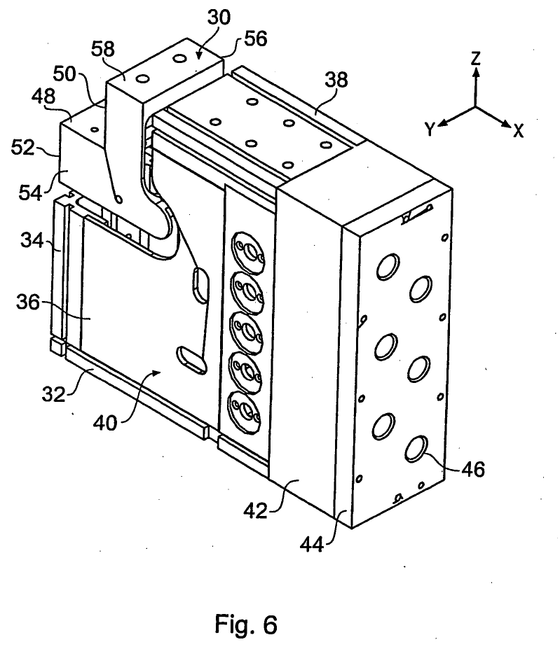

FIG. 6 is a perspective view of a device embodying the invention. The device is a 6-axis positioner with x, y, z, roll, pitch and yaw degrees of freedom. The device is made up of a moving part or “world” 30 on which items to be manipulated can be mounted. The moving world 30 has a variety of surfaces for attaching a sample to be positioned. There are no fewer than six mounting faces, any or all of which can be provided with standard mounting features, such as threaded holes, plugs or grooves.

The moving world 30 is suspended by a positioning unit 40, the internal construction of which is described in detail in the following. The positioning unit 40 has a piezo drive block 42 connected to its drive input face. The piezo drive block 42 has in turn a micrometer drive input block or “dongle” block 44 attached to it which has six drive mounts 46 on its back plane for receiving a plurality of micrometer-type drive inputs. It will be appreciated that the piezo drive block 42 is optional and may be omitted if not needed for fine motion control.

The positioning unit 40 comprises a base 32 which forms part of the fixed “world” and from which the fixed world internal components are built upon. Front, side and top covers 34, 36 and 38 complete the exterior housing of the positioning unit 40. The front cover 34, side covers 36, top cover 38 and base 32 all constitute mounting faces provided with a mixture of locating grooves and threaded fixing holes for mounting to optical tables, breadboards and also other similar positioning devices.

Inside the positioning unit 40, six drive trains are connected between the drive inputs actuated by the piezo drives inside the piezo drive block 42 (fixed world) and the moving world 30, the drive trains being configured to move the movable part relative to the fixed part in the six different motion axes responsive to the drive inputs received via the piezo and micrometer drives.

One important and innovative aspect of the design is immediately evident from the figure, namely that the positioning unit has a plurality of orthogonal mounting faces. These allow the moving world to be arranged in different orientations. The moving world need not be upright as illustrated, but can be fixed on its side, upside down, on its back or in any other orientation. It is noted that the cuboid exterior design form enables mounting in different orientations, but it is the interior design of the drive trains that allows practical usage of the device in different orientations, bearing in mind that the gravity-induced loads are different depending on the device orientation. This is quite different from a conventional positioner in which the drive trains are designed only to meet specification in one particular orientation.

According to the cuboid design concept, the moving world 30 is confined to fit within a corner portion of a cuboid defined by six planes, five of which coincide with the mounting faces 32, 34, 36 (two faces) and 38, and the other of which coincides with the face of the positioning unit that interfaces with the piezo drive block 42.

The moving world 30, when viewed as a cuboid, has four sides facing externally and two sides facing internally. This is made possible by the design of the drive trains which have been configured to access the moving world 30 solely from the two internally facing sides. This leaves the four external sides free for utilisation for sample mounting and access, e.g. by manipulators. Thus, six motion axes can be provided by actuation of the moving world from only two sides.

In fact, in this embodiment, the moving world 30 is not cuboid, but L-shaped in cross-section to provide six access and/or sample attachment surfaces in total, including two externally facing sample attachment surfaces 48, 50 that extend parallel to the internally facing sides, and four sample attachment surfaces 52, 54, 56, 58 aligned with the four externally facing sides of the moving world.

Moreover, as well as all six drive trains actuating the moving world end through only two sides, all six drive trains are actuated on the fixed world end from a single drive input face, namely the face that connects to the piezo drive block 42. This feature is of major significance, since it allows the orientation freedom of the device by providing that all the micrometer drives and their cabling emerge from one side of the device confined within the device cross-section, thereby allowing mounting on a flat surface using the top, bottom or either side as the mounting face.

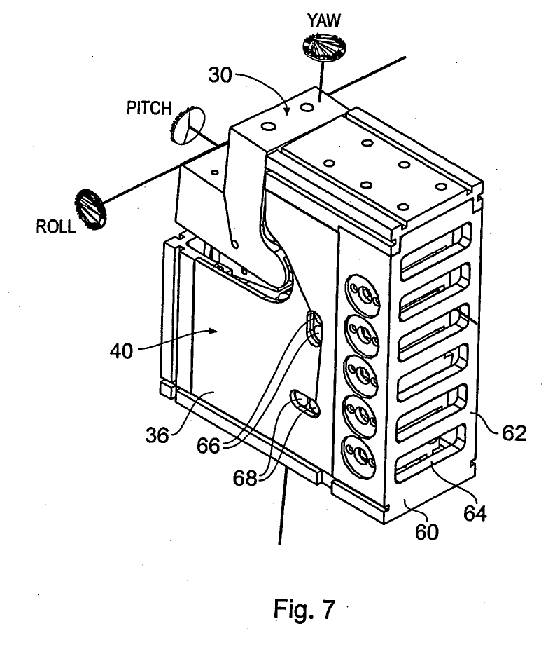

FIG. 7 is a perspective view with the piezo drive block and dongle block removed to reveal the drive input face 60 of the positioning unit 40. The yaw, pitch and roll axes are also illustrated schematically showing their position relative to the mounting faces of the moving world 30. The drive input face 60 is thus parallel to, and faces in an opposite direction to, the front cover mounting face 34.

The drive input face 60 is part of a “letterbox” housing 62, where the term letterbox is used since each of the six drive trains is designed to terminate and be actuatable through a slotted access aperture or “letterbox” opening 64 in the housing. From the top to the bottom, the letterbox order is x, yaw, y, roll, z, pitch.

In the illustrated example, six letterbox openings are provided. However, a useful production aspect of the design is that the number of motion axes can be restricted to less than six simply by providing a different letterbox housing with fewer access slots 64. In other words, the drive input face 60 can provide access apertures for only a subset of the drive trains to limit drive inputs to that subset of the drive trains. In this way, an xyz positioner, or xyz & yaw positioner, or any permutation of the six axes can be provided simply by changing one part of the whole assembly.

Also evident in the figure, are two pairs of holes 66 and 68 which pass right through the positioning unit 40 from one side cover 36 to the other. These allow passage of clamping bolts through the device and can be used for clamping two or more positioning units to each other side-by-side, or to clamp a single positioning unit to an optical table or breadboard, e.g. with the positioning unit on its side.

Having described the external design of the device, the main internal components are now described. This description is then followed by a description of each of the six drive trains in turn.

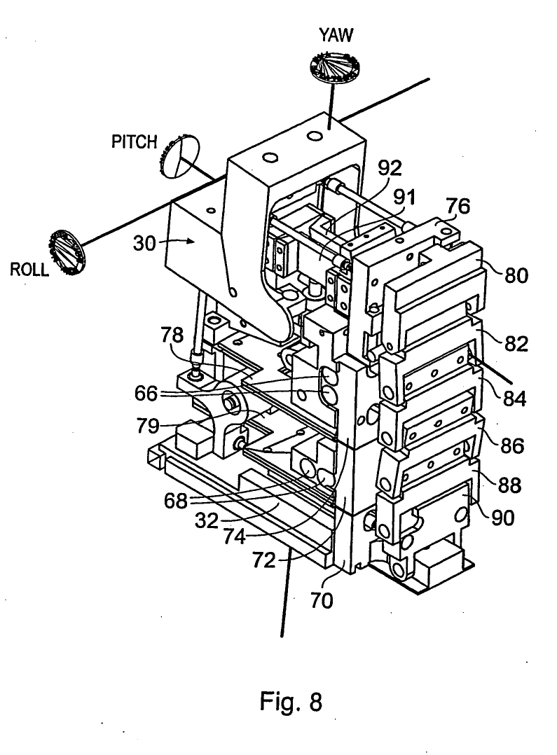

FIG. 8 is a perspective view of the device with the side and top covers and letterbox housing removed to reveal internal structure, in particular how the drive trains link to the moving world 30. Behind the letterbox housing adjacent to the drive input face there are six pivot plates, one for each motion axis. Namely, starting from the top, there are letterbox pivot plates 80, 82, 84, 86, 88 and 90 for x, yaw, y, roll, z and pitch respectively. The x and yaw pivot plates 80 and 82 act on an intermediate world 76 that is pivotable about two orthogonal axes. These elements are described in more detail further below. The fixed world components are built up on the base 32. Vertically extending part 70 is fixed to the base 32. A further vertically extending part 72, which acts as a separator for a pair of flexure elements 78 and 79 associated with the z-drive, is mounted on the part 70. (The y drive also incorporates flexure elements 91 and 92 which can also be seen towards the top of the figure.) The part 72 also includes the through holes 68. On top of the part 72 there is arranged an upper part 74 that forms a further part of the fixed world and includes the through holes 66. Although it is difficult to quickly understand the detailed design of the drive trains from this figure, it can be seen that they use a mixture of rod-like linkages, flexure elements, spigots and cranks.

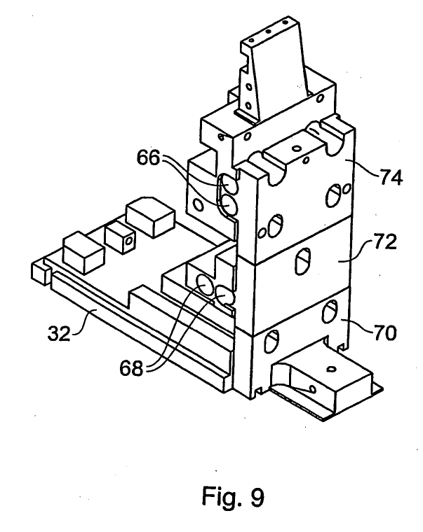

FIG. 9 is a perspective view showing only the fixed world parts of the device, namely the parts 32, 70, 72 and 74 described above with reference to FIG. 8. The through holes 66 and 68 are also indicated. It can be seen that the top part of the upper fixed world part 74 includes a mounting flange for the y flexure elements 91 and 92 shown in FIG. 8.

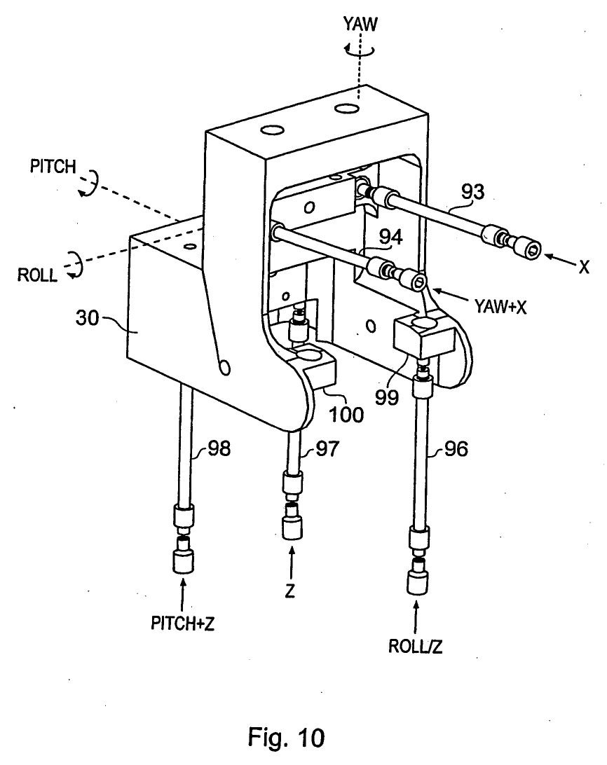

FIG. 10 is a perspective view of the moving world 30 together with the drive linkages that directly contact it. This drawing is useful for understanding how the moving world 30 is acted upon to produce the various axes of motion.

The vertical internally facing side of the moving world 30 receives two linkages 93 and 94. Linkages 93 and 94 are displaced in unison to cause x motion. Linkage 94 is moved on its own to produce yaw motion. One end of each linkage is fixed to the moving world by screwing into threaded apertures.

The horizontal internally facing side of the moving world 30 receives three linkages 96, 97 and 98 on three of its four corners. The upper end of each linkage is fixed to the moving world by screwing into threaded apertures. A lug 99 including the mounting aperture for the linkage 96 is evident. A further lug 100 can also be seen. This is vacant in the illustrated example. This second lug is included for production convenience since it means that the same moving world 30 can be used for left and right-handed devices. It will be understood that in an opposite handed design the linkage 96 will be fitted into the lug 100 with the lug 99 being vacant. Linkage 96 is moved on its own to produce roll motion. Linkages 96, 97 and 98 are moved together to produce z motion. Linkage 98 is moved on its own to produce pitch motion. It will be noted that no mention has been made of y motion. This is because y motion is not produced by a rod linkage acting on the moving world, but by a flexure element which is not shown in this figure. One end of a flexure is mounted inside the moving world 30 and the y drive train acts to push the flexure sideways (not shown).

In summary, the moving world 30 is actuated by three flexible linkages 96, 97, 98 extending into a downwardly facing one of the internally facing sides to control z, pitch and roll motion, and two flexible linkages 93, 94 extending into a sideways facing one of the internally facing sides to control x and yaw motion. By contrast, y motion is actuated through a flexure drive (not shown).

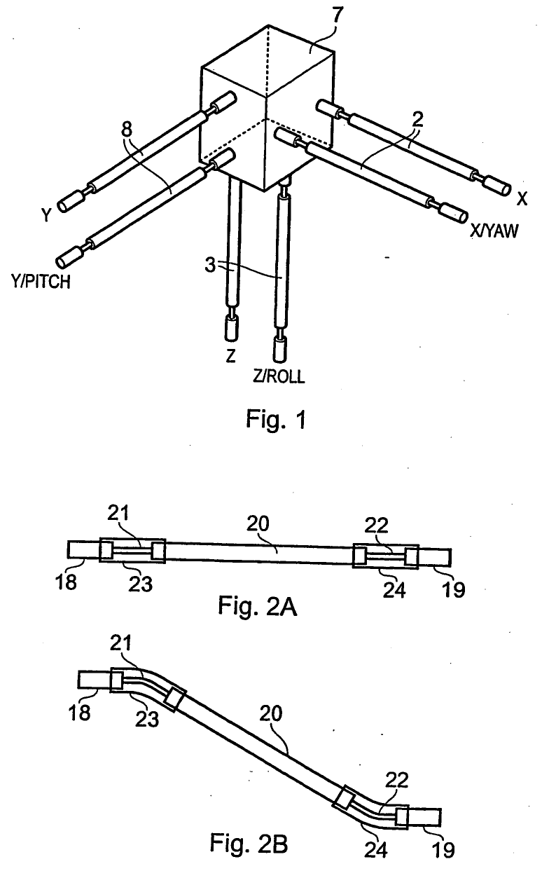

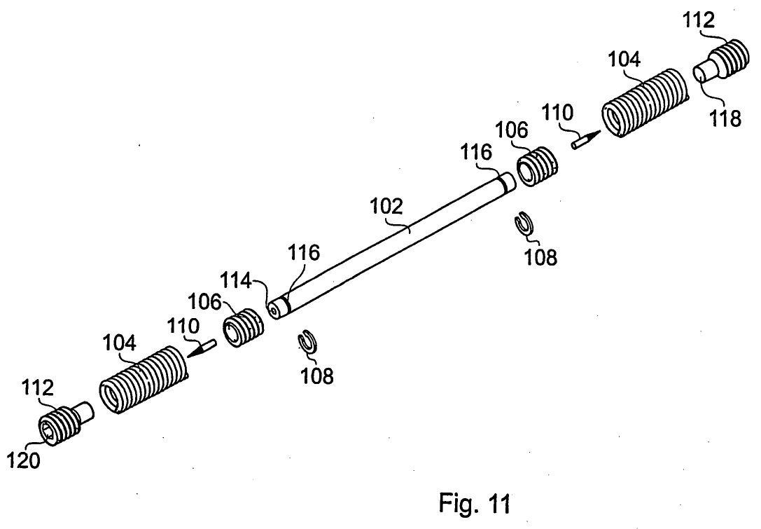

FIG. 11 is an exploded view of one of the linkages. All the linkages use the same design. Because of the design concept of the device, which is to allow usage in any orientation, conventional flexure linkages could not be used. In particular, the flexure linkages of the prior art shown in FIGS. 2A and 2B are unsuitable, since they would buckle or plastically extend as a result of the compression and extension loads that the linkages would be subjected to. To overcome this problem, a new flexible linkage has been designed, as illustrated in exploded form in the figure.

A rod 102 has an axial hole 114 drilled in each end into which is adhesively bonded a needle or pin 110 with a conical tip. To assemble, inner helical springs 106 are sleeved onto the rod 102 past a pair of circlip locating grooves 116. Circlips 108 are then fitted, the inner sides of which then act as abutment faces for the outer ends of the inner springs 106. Two outer helical springs 104 are then threaded onto the inner springs 106. The inner and outer springs are wound so that they can be threaded together in this way. In the present implementation, the outer springs have an internal form equivalent to a M5 thread. The external form that follows from this gives an M6.6 thread that corresponds with the threads on the lugs, such as the previously mentioned lugs 99 and 100. A pair of end parts 112 are then screwed into the other end of the outer springs 104. The end parts 112 have a threaded outer form to allow them to screw into the inside of the outer springs 104, i.e. a pitch matched to the pitch of the coils of the outer springs 104, and a hex socket receiving aperture 120 at their outwardly facing ends to allow convenient threading. At their inwardly facing ends, there is a body into which a conical recess 118 is machined. This is a 90° cone in the present implementation. The point of the cone, i.e. the base of the recess, has a very small radius into which the needle 110 sits in the assembled linkage, thereby locating the needle at the base of the cone. The needle 110 has a parabolic end. This produces a very fine ball-and-socket joint to give smooth motion of the needle 110 in the conical recess 118 within an angular range of approximately ±6 to 10°. (By contrast, the prior art wire-based linkage of FIGS. 2A & 2B is restricted to provide an angular range of approximately ±2°.) It will be appreciated that with this design the joint is held under compression, wherein the amount by which an end part 112 is screwed into the outer spring 104, and also the amount by which the outer spring 104 is screwed onto the inner spring 106, will determine the level of the compressive force. In this way, the present implementation allows the joints to be held in compression under anything between 2 to 11 kg force. Each joint is thus held under compression by a resilient biasing element, namely a spring, that forms part of the linkage and is connected under tension between the end part and its adjacent rod.

It is noted that the inner springs 106 can be eliminated by used of necked springs. In a variation, the needle and cone design could be changed so that the joints are formed by a ball seated in a socket. In the illustrated embodiment, the threaded portion on the end part is a male thread that is threaded into the inside of the helical spring, but in an alternative embodiment, the threaded portion on the end part could be female and threaded onto the outside of the helical spring. Another alternative would be to provide the rods with a threaded portion having a pitch matched to the pitch of the coils of the helical spring, the rods being connected to the helical spring by threaded engagement of the threaded portions in the spring coils. This would allow elimination of the inner springs. The threaded portion on the rod could be a male thread that is threaded into the inside of the helical spring. Alternatively, the threaded portion on the rod could be a female thread that is threaded onto the outside of the helical spring. The threaded portions on the rods could be formed by further helical springs fitted over the rod.

This design of linkage allows drive trains to be built that can cope with a very wide range of possible loads, thereby allowing the device to satisfy a stringent specification in terms of positioning accuracy for all possible mounting orientations. In simple terms, this is because very high compressive forces can be pre-loaded into the joints with springs, so that they cannot be easily pulled apart. The needle and cone joint is capable of withstanding the high compression forces that result from the sum of the compression force from the springs and any compression force that results from loads during use. At the same time, the necessary flexibility in the linkages is provided. The joints are thus held under self-compression by bracing of the internal springs, analogous to how the human knee joint is held together by its ligaments. A high degree of flexibility is a requirement of a true multi-axis positioner (as opposed to multiple stacked single axis positioners), since each drive train must be rigid to transmit forces along it and, at the same time, deformable to accommodate motion in the other motion axes. As well as excellent performance, the linkage is inexpensive to produce and simple to assemble. In the present device, the linkages are used in all the drive trains.

In addition to the pre-load provided by the springs 104 that form part of the linkages, i.e. the internal springs, in the assembled positioner additional pre-load can be applied by springs that are separate from the linkages, i.e. external springs. Such external springs can be arranged to extend roughly parallel to the linkages and are secured at each end to the fixed world, intermediate world, or moving world as appropriate. (Examples of these external springs are illustrated in some of the later drawings.) In the assembled positioner, the compression force of the pre-load is then made up of two components, one from the ‘internal’ springs and one from the ‘external’ springs. Typically, the external springs will provide the dominant contribution for higher pre-loads.

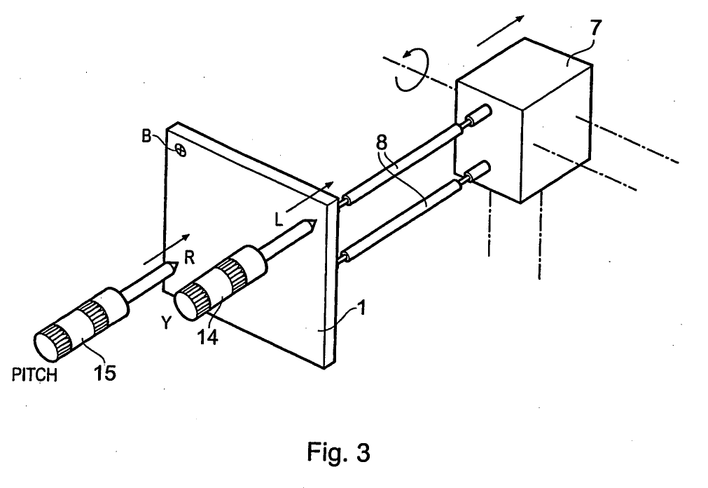

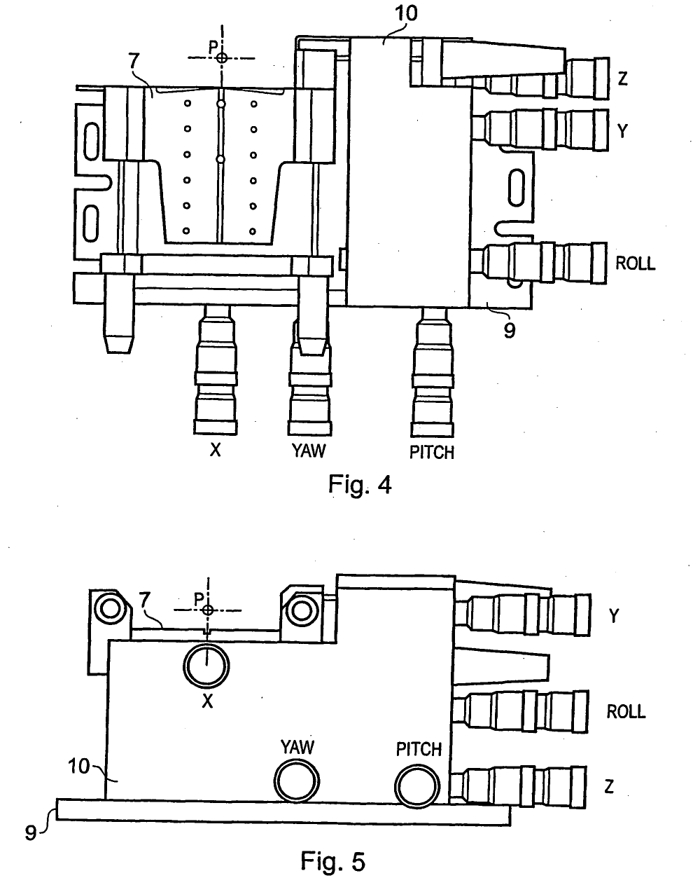

It will also be appreciated that these linkages can be used in a wide range of designs of positioners, not just the present device. In particular, the linkages could be used in the design described with reference to FIGS. 1 to 5 to replace the linkages shown in FIGS. 2A and 2B.

Each of the drive trains is now described in turn.

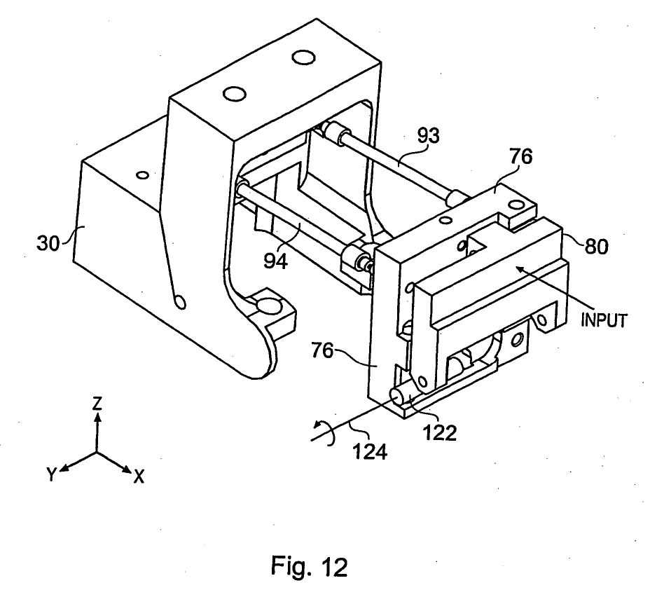

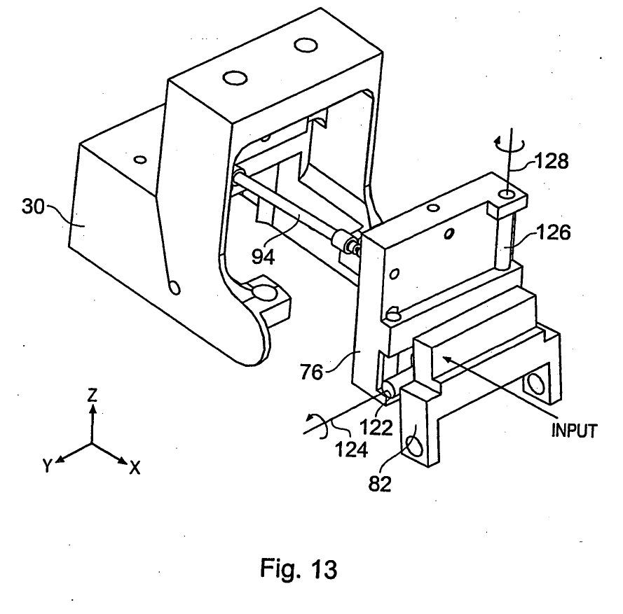

FIG. 12 is a perspective view showing the principal components of the x drive train. As already described with reference to FIG. 8, the x drive train comprises two of the flexible linkages 93 and 94 of FIG. 11 which extend approximately parallel to connect at one end to either side of the moving world 30 and at the other end to an intermediate world plate 76. The linkages 93 and 94 are displaced in unison to cause x motion by pivoting of the intermediate world plate 76 about a pin 122 that rotates about an axis 124. The intermediate world plate 76 is actuated by point contact, e.g. a roller or ball bearing contact, from the x pivot plate 80. The x pivot plate 80 is in turn actuated by a point contact, such as a micrometer spindle or piezo actuator, acting at around the point marked by the arrow labelled INPUT. The x pivot plate actuation will be through the piezo drive block 42 or micrometer drive input block 44, as shown in FIG. 6. The intermediate world plate 76 and moving world are held in contact by a spring held in tension between them (not shown). Plates 76 and 80 are held in contact by a return spring (not shown).

FIG. 13 is a perspective view showing the principal components of the yaw drive train. It will be recognised that many of the components are common to the x drive train. The linkage 93 shown in FIG. 12 is not illustrated since this remains static during yaw motion. Linkage 94 is moved on its own to produce yaw motion of the moving world 30. Linkage 94 is moved by pivoting of the intermediate world plate 76 about the vertical axis 128 defined by pin 126 which bears on the x motion letterbox which remains static. The axis of the vertical pin 126 crosses the axis of the horizontal pin 122 at the bottom right corner of the intermediate world plate 76 (as viewed in the illustration) with a universal joint existing to continue the axis of the crossed pair of pins. This universal joint allows the intermediate world plate 76 to pivot about axes 124 and 128 to provide x and yaw motion respectively. The intermediate world plate 76 is actuated by point contact, e.g. a ball bearing contact, from the yaw pivot plate 82. The yaw pivot plate 82 is in turn actuated by a point contact, such as a micrometer spindle or piezo actuator, acting at around the point marked by the arrow labelled INPUT.

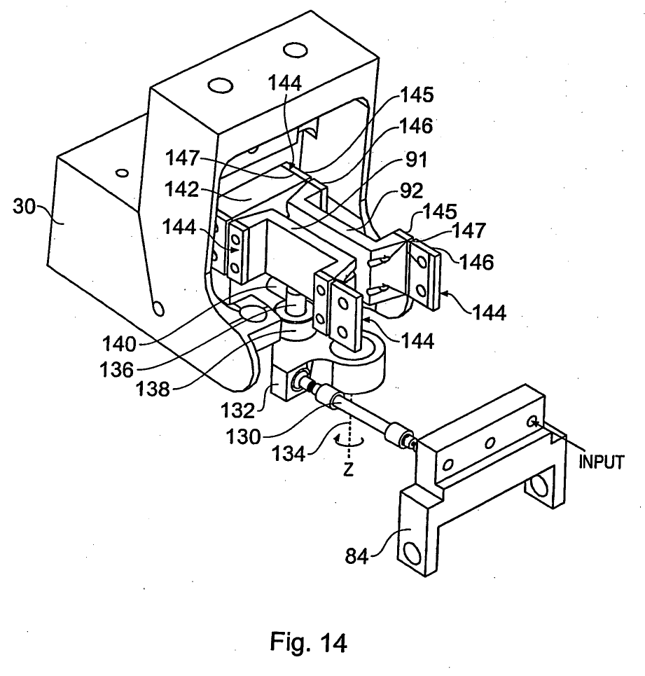

FIG. 14 is a perspective view showing the principal components of the y drive train. The y drive train is different from the x and yaw drive trains, since it includes flexure components. It also includes parts to convert the initial actuation which is along the x axis perpendicular to the drive input face into a horizontal actuation along the y axis. Starting from the y pivot plate 84, initially mentioned above when describing FIG. 8, a flexible linkage 130 of the type shown in FIG. 11 acts on one arm of a bell crank 132 that pivots about a vertical axis 134 defined by a bearing (not shown). The joints at either end of the linkage 130 accommodate movement of the other drive trains, as already discussed. The inner bearing race of the bell crank 132 is mounted rotatably on a spindle (not shown) which is mounted to the fixed world part 74.

The bell crank 132 has a further arm, extending at right angles to the arm on which the linkage 130 acts, on which a vertical pin 136 is journalled in a bearing 138. It will thus be appreciated that motion of the y pivot plate 84 moves the linkage 130 which rotates the bell crank 132 about vertical axis 134, thereby moving vertical pin 136 in the y direction. The vertical pin 136 tangentially abuts a further pin 140 which extends horizontally in the x direction to form a cross with the vertical pin 136. The horizontal pin 140 is connected to a moving slug 142 that is fitted inside the moving world 30. It will thus be appreciated that the bell crank initiated y motion of the vertical pin 136 causes y motion of the horizontal pin 140 and moving slug 142 which in turn moves the moving world 30 in the y direction, thereby causing the desired motion. This y motion is constrained by a pair of flexure elements 91 and 92 which are connected at one end to the moving slug 142 and at the other end to the mounting flange of the upper fixed world part 74, mentioned above when describing FIG. 9. The y flexure stiffener elements 91 and 92 are secured by flexure hinges 144, each comprising two clamp parts 145, 146 and a flexible flexure sheet 147 extending between the clamp parts. Finally, it will be understood that the whole y motion is initiated by a point contact, such as a micrometer spindle or piezo actuator, acting at around the point marked by the arrow labelled INPUT, on the y pivot plate 84.

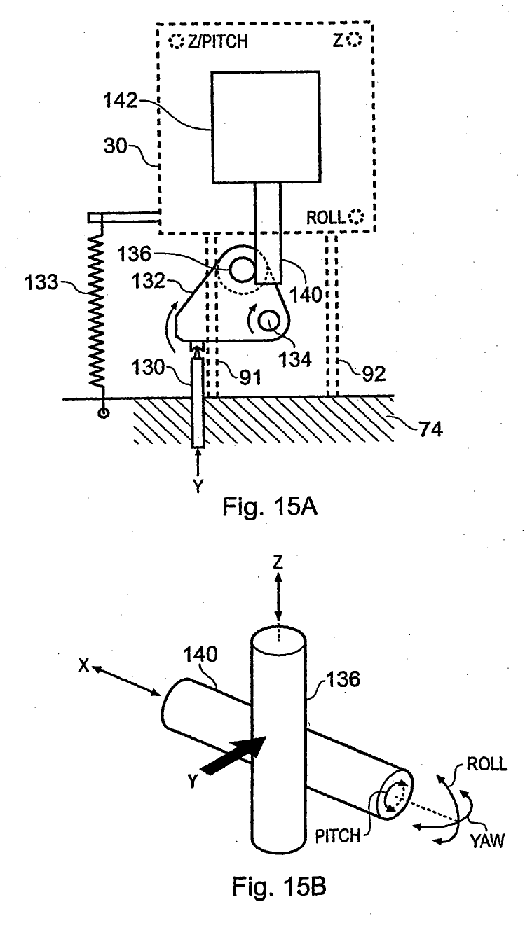

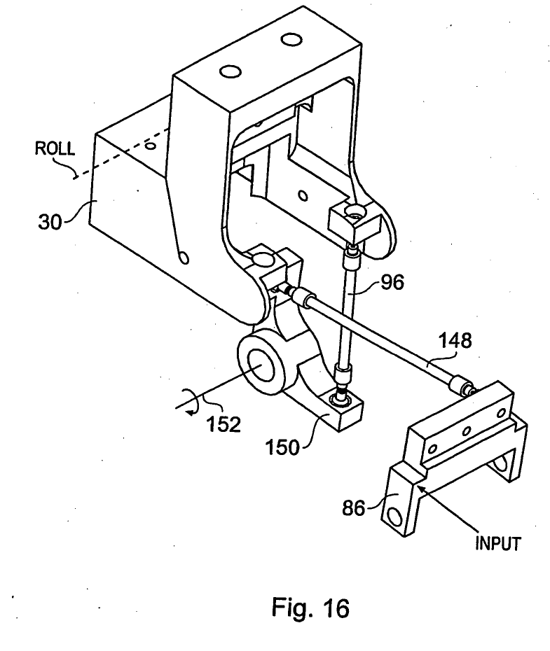

FIG. 15A is a highly schematic plan view summarising the principles of the y drive train just described. Pushing actuation of the linkage 130 rotates the bell crank 132 about axis 134 pushing the vertical pin 136 against the horizontal pin 140 to move the moving slug 142 and thus the moving world 30 as constrained by the flexure stiffeners 91 and 92 held at one end by the fixed world 74. It will be appreciated that the opposite motion is generated by withdrawal of the linkage 130. In this case, the crossed pins 136 and 140 are held in contact by a spring (not shown) extending in the y direction and held in tension between the pin 140 (or part connected thereto) and the fixed world 74. The spring thus acts as a resilient biasing element that exerts a pulling force on one of the pins towards the other. Also illustrated is a further spring 133 which is held under tension between the moving world and the fixed world 74 to exert an additional compressive force component on the joints of the linkage 130. This is an example of the ‘external’ springs referred to above.

FIG. 15B shows the role of the crossed pins of the y drive train and how they move to accommodate motion of the other axes. First, the thick arrow indicates y actuation in which the crossed pin pair 136, 140 allows force transmission as part of the y drive train. The figure also shows with the smaller arrows how the crossed pin joint is free to move to accommodate motion in each of the other five motion axes. For x motion, horizontal pin 140 can move in the x direction, which will result in vertical pin 136 rolling as allowed for by its bearing mounting in the bell crank. For yaw motion, horizontal pin 140 will roll about the vertical pin 136. For roll motion, horizontal pin 140 will rotate about a point of contact on the vertical pin 136. For z motion, vertical pin 136 will slide on the horizontal pin 140. Finally, for pitch motion, horizontal pin 140 rotates about its own axis.

The y drive train thus includes mutually contacting crossed pairs of pins that can slide and rotate on each other to accommodate movement of the other drive trains. Pins are convenient to use, but other components could be used, with the generic term spigot being used elsewhere in this document. The spigots are preferably arcuate in cross-section. This is conducive to them contacting each other tangentially. It is noted that a similar crossed pin pair is used as part of the z drive train, as will be described further below.

FIG. 16 is a perspective view showing the principal components of the roll drive train. The roll drive train initiates with input from an external actuator as marked by the INPUT arrow in the drawing to contact the roll pivot plate 86 which in turn actuates a flexible linkage 148 attached at one end to the roll pivot plate 86 and at the other end to a vertical arm of a bell crank 150 which is rotatably journalled to rotate about an axis 152 by a bearing (not shown) secured to the z intermediate world by a spindle (not shown). The z intermediate world is described further below. The bell crank 150 has a further arm extending horizontally in which is secured one end of a further flexible linkage 96, the other end being connected to the moving world 30. The flexible linkage 96 was initially mentioned when describing FIG. 10. It will thus be appreciated that actuation of the roll drive input will push (or pull via a return spring that acts against the actuator) the back end of the moving world to cause it to rotate about the roll axis, with the flexible linkages 97 and 98 (see FIG. 10) remaining static. It is noted that to accommodate this roll motion the crossed pin pair of the y drive train will move as illustrated in FIG. 15B and the joints of the linkages 93, 94, 97 and 98 will distort, as can be appreciated from FIG. 10.

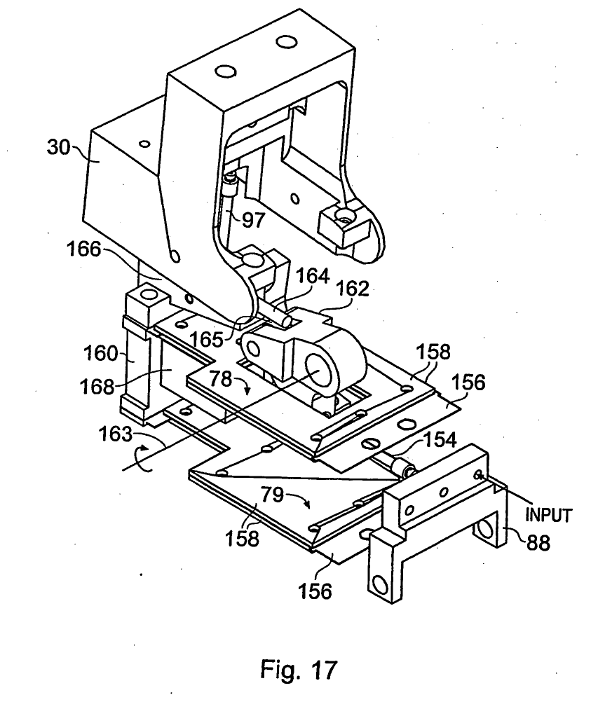

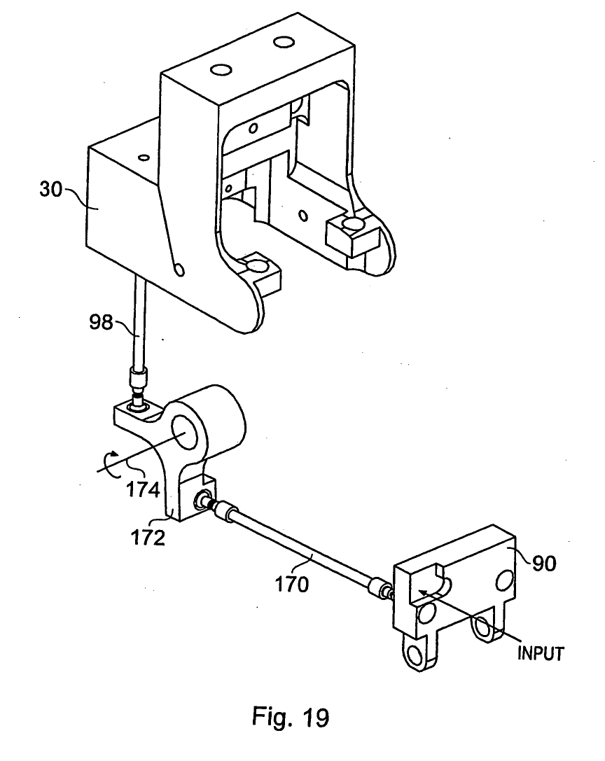

FIG. 17 is a perspective view showing the principal components of the z drive train. The z drive train is conceptually similar to the y drive train in that it includes a crossed pair of pins, a flexure design to constrain the motion, and a bell crank to redirect the transmitted forces from perpendicular to the input drive face to the desired motion direction. A drive input, marked in the drawing with an arrow labelled INPUT, actuates the pivot plate 88 first shown in FIG. 8. The z pivot plate 88 acts on a flexible linkage 154 the other end of which is secured in a downwardly extending arm of a bell crank 162 which is bearing mounted to rotate about an axis 163 that extends in the y direction. A second arm of the bell crank 162 extends horizontally in the x direction away from the drive input face and has mounted therein a extending spigot or pin 165 which is free to rotate in a bearing about an axis extending in the y direction. The horizontal pin 165 tangentially abuts a further pin 164 arranged in crossways fashion extending in the x direction. The pin 164 is secured to a nose 166 of an intermediate world 160 which also includes a spur 168 for mounting the spindle on which the roll drive train's bell crank 150 is journalled (see FIG. 16). The intermediate world 160 is connected to the moving world 30 by the linkages 97 and 98 (see FIG. 19 below for illustration of linkage 98). Linkage 97 is purely for the z motion, whereas linkage 98 is used for both z and pitch motion. The pure z linkage 97 is secured at its lower end directly to the intermediate world 160, whereas the mixed z and pitch linkage 98 is secured at its lower end indirectly to the intermediate world 160 to allow pitch actuation as well as z actuation, as is described further below.

In use, rotation of the z pivot plate 88 horizontally displaces the linkage 154, which rotates the bell crank 162 and vertically displaces the intermediate moving world 160 through the crossed pair of pins 164, 165. Vertical displacement of the moving world 160 then vertically displaces the linkages 97 and 98 which in turn causes the desired z motion of the moving world 30. This motion is constrained by the parallel flexures 78 and 79. Each of these flexures has a sandwich construction, with a flexure sheet 156 arranged between two straps 158. The sheets extend beyond the straps in the x direction to form clamping flanges for the fixed world parts at one end (not shown in FIG. 17) and the intermediate world parts at the other end.

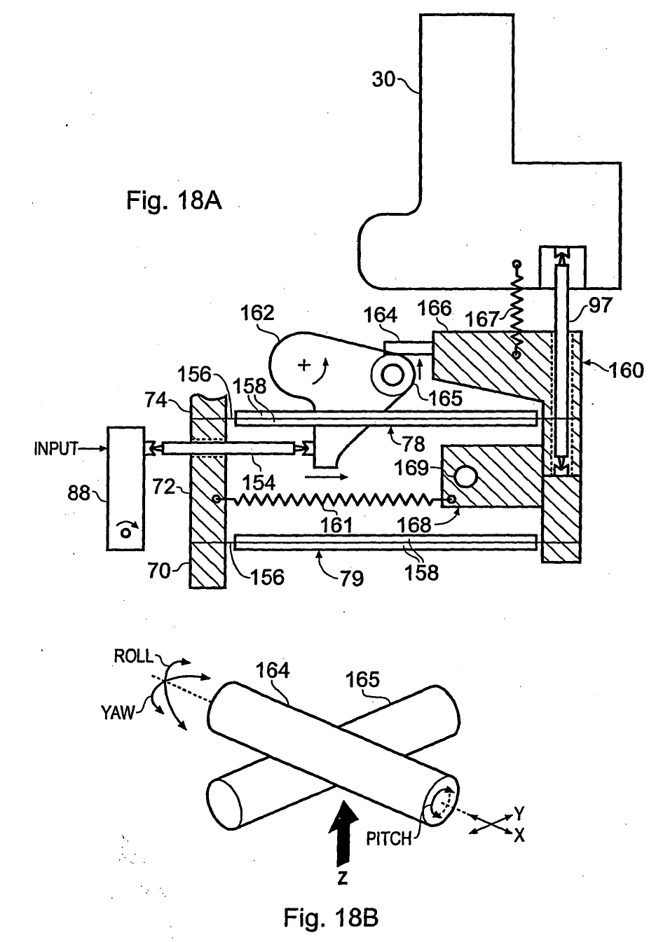

FIG. 18A is a side view from the far side of FIG. 17 showing the principal components of the z drive train in a schematic fashion. The upper and lower flexures 78 and 79 respectively can be seen, each made up of a sheet 156 and a pair of straps 158. The lower sheet is clamped between fixed world parts 70 and 72, and the upper sheet between fixed world parts 72 and 74 (see FIG. 9). The intermediate world 160 is also split into separate parts to provide similar clamping at the other end of the flexure sheets as illustrated. As is evident, forward pushing of the pivot plate 88 causes rotation thereof and pushing of the linkage 154, which in turn pushes the downwardly depending arm of the bell crank 162, rotating the bell crank 162 and pushing the pin 165 upwards, thereby pushing the intermediate world 160 up, via contact with the pin 164 embedded in the nose 166 of the intermediate world 160, against the resilient biasing of the flexures 78 and 79. Upward motion of the intermediate world 160 pushes on the linkage 97 (and linkage 98) which moves the moving world 30 upwards in the z direction. For pulling actuation, pins 164 and 165 are maintained in contact via a spring (not shown) held in tension between the intermediate world 160 and the fixed world (e.g. the base 32—see FIG. 9). Also evident in the figure is a spindle receiving aperture 169 in the intermediate world spur 168. This is for receiving the spindle by which the roll drive train bell crank 150 is mounted (see FIG. 16).

Also illustrated are springs 161 and 167 which are ‘external’ springs provided to apply additional compressive force to the drive train linkages. Spring 161 extends between fixed world part 70 and intermediate world part 168. Spring 167 extends between intermediate world part 166 and moving world part 30. These springs can be secured in any conventional manner, e.g. using pins, lugs etc.

FIG. 18B shows the role of the crossed pins of the z drive train and how they move to accommodate motion of the other axes. The thick arrow indicates z actuation in which the crossed pin pair 164, 165 allows force transmission as part of the z drive train. The drawing also shows with the smaller arrows how the crossed pin joint is free to move to accommodate motion in each of the other five motion axes. For x motion, pin 164 moves along its axis inducing pin 165 to rotate in its bearing. For yaw motion, pin 164 rotates about a point of contact on pin 165. For y motion, pin 165 moves along its own axis relative to pin 164. For roll motion, pin 164 rolls around a circumferential line of contact on the surface of 165. Finally, for pitch motion pin 164 rotates about its own axis.

FIG. 19 is a perspective view showing the principal components of the pitch drive train. The pivot plate 90 first illustrated in FIG. 8 is actuated at around the point indicated by the INPUT arrow by a suitable drive to push or pull the flexible linkage 170 which extends between the pivot plate 90 and a downwardly depending arm of a bell crank 172. The bell crank 172 rotates about an axis 174 extending in the y direction and serves to transmit the x-direction force from the linkage 170 to a z-direction force. This is done through a horizontally extending arm of the bell crank 172 which seats the lower end of a further linkage 98, this being the linkage that is visible in FIG. 8 (but not labelled) and first described with reference to FIG. 10. The upper end of linkage 98 seats in the moving world 30. The pitch drive bell crank 172 is journalled coaxially with the roll drive bell crank 150 by the other end of the aperture 169 shown in FIG. 18A. The pitch drive bell crank 172 thus rides on the intermediate world 166 so that the linkage 98 can contribute to the z drive when the bell crank 172 remains static and provides the pitch drive when the bell crank 172 is rotated to move the linkage 98 relative to the linkage 97.

Having now described each of the six drive trains, the overall motion of the moving world is summarised.

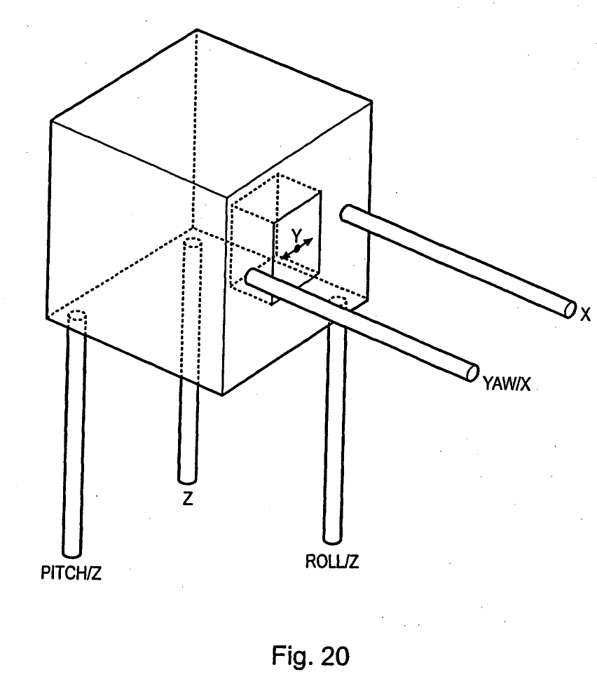

FIG. 20 is a schematic perspective view summarising the principles of operation of the device embodying the invention. This is to be compared with the prior art FIG. 1. In the prior art design, there are three pairs of parallel linkages acting on three mutually orthogonal faces of a cuboid. One pair provides x & yaw, another pair provides y & pitch and the third pair provides z & roll motion. In the device embodying the invention, there is one pair of parallel linkages acting on a first face of a cuboid and a set of three parallel linkages acting on a second face of the cuboid orthogonal to the first. In addition there is a blade-type flexure acting on the interior of the cuboid. The flexure provides y motion, the pair of parallel linkages provide x & yaw motion, and the set of three parallel linkages provide z, roll & pitch motion. The moving world is thus manipulated from only two of the cuboid faces, as opposed to three in the prior art design. In addition to the conceptual differences from a geometric standpoint, it will be appreciated that the flexible parts of the linkages in the prior art are made of wires that can bend and twist, whereas ball and socket joints held together by ligament-like tensioning elements that are part of the linkages themselves are used in the embodiment of the invention.

Having described the device embodying the invention, some applications examples are now given to illustrate the versatility that the cuboid, orientation-free design concept provides. In each case the positioners are shown relative to a breadboard used for mounting. It is noted that in the applications examples, the positioners are opposite handed to the positioner described with reference to FIGS. 6 to 20. This change is of no particular significance.

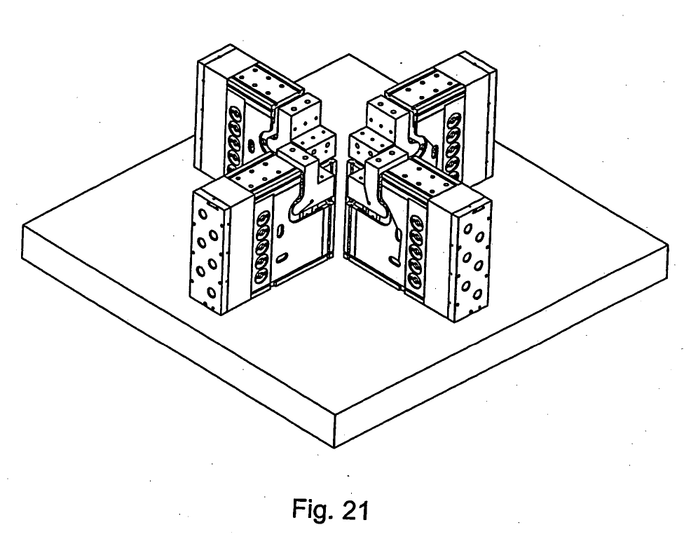

FIG. 21 shows four devices arranged upright in a cross according to a first applications example. The positioners can be fixed to the optical breadboard using mushroom cross-section slots in the base plate 32 which engage with mushroom shaped fasteners threaded to holes in the breadboard. In this configuration four moving worlds are facing each other. Alternatively, they can be clamped using the side slots evident in FIG. 7. This kind of arrangement is useful for small integrated optical devices with multiple input/outputs on different sides, such as a four-sided optical cross-connect.

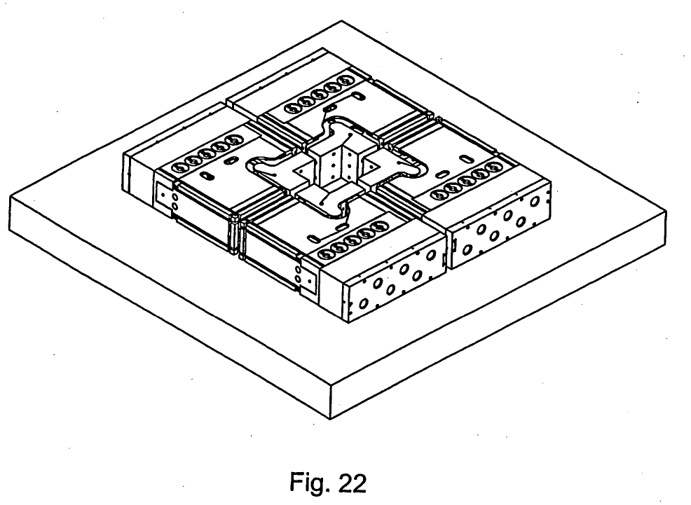

FIG. 22 shows four devices arranged on their sides in a square according to a second applications example. Here the positioners are bolted to the breadboard using the holes 66 and/or 68 (see FIG. 7). This arrangement provides a very low profile multi-axis positioning facility with a square internal section.

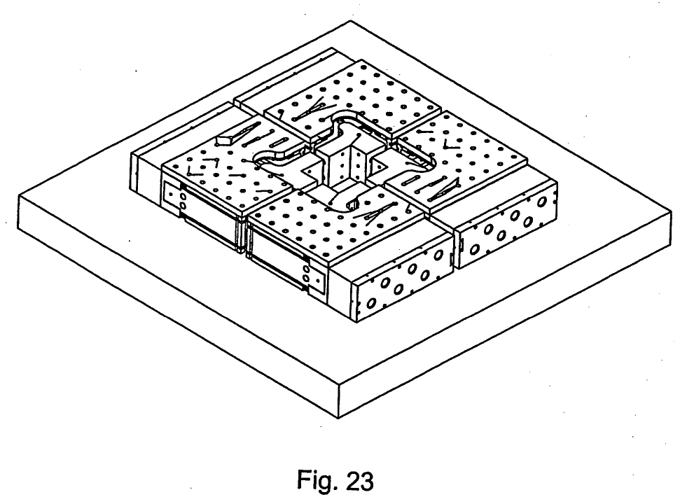

FIG. 23 shows four devices arranged on their sides in a square with mini modular breadboards on their upper surfaces according to a third applications example. This is similar to the second example, but in addition shows how plates with arrays of threaded holes distributed in a standard optical table grid (e.g. 25 mm, 50 mm, 1 inch or 2 inch) can be bolted onto the side covers 36 (see FIG. 7) of the positioners to provide a platform for further components to be secured. In this arrangement, a four-sided optical cross-connect could be mounted in a fixed position in the central gap directly on the underlying breadboard and, on the side sample attachment surfaces 54 (facing upwards) of each of the moving world parts, a fibre block could be mounted for coupling into and out of one of the four input/output ports of the cross-connect. Each fibre block could thus be independently manipulated with the desired degrees of freedom.

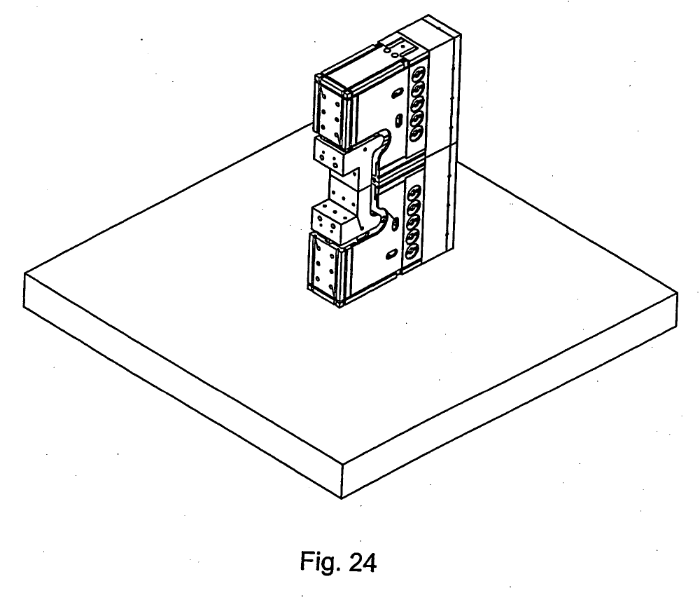

FIG. 24 shows two devices arranged with one inverted on top of the other according to a fourth applications example. The two positioners are clamped together using clamping pieces (not shown) that engage in the side grooves in the top cover 38 (see FIG. 7).

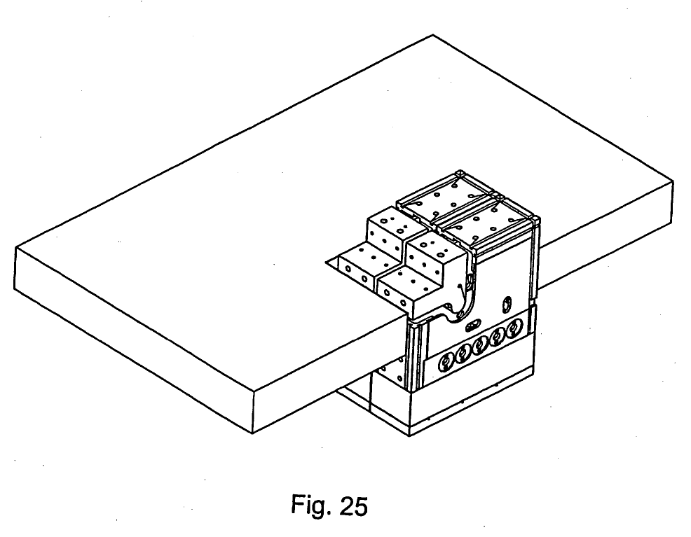

FIG. 25 shows two devices ganged together side-by-side and arranged on their backs recessed in a breadboard according to a fifth applications example. Long through-bolts (not shown) extend through two or more of the holes 66 and/or 68 to bolt the two devices together and onto the side of the breadboard, e.g. by an L-bracket from the breadboard surface (not shown) or an eccentric cleat. This arrangement could be used for coupling into a U-shaped waveguide. The U-shaped waveguide module would be fixed to the breadboard with its two ends facing the two moving worlds, on which are mounted two fibre blocks. Each fibre block is then independently manipulatable to align with either end of the U-shaped waveguide.

With this through-table mounting in a back orientation, the drive input face 60 is in the xy plane facing downwards and lying below the work surface. Consequently all the drives and their connection cables are out of sight below the breadboard and pointing downwards for convenient cable routing. Connecting “spaghetti” is thus completely removed from the work environment providing an exceptionally elegant and practical design solution. (Another applications example inverts this arrangement and adopts one or more positioners lying front down with the drives pointing upwards. This can be used to mount positioners at a high level in the work space, with the cabling being routed out above the work space, e.g. into a gantry.) In the present example, the recessed mounting also results in the manipulation axes being only a short distance above the surface of the breadboard. Consequently, if for example the application relates to a free-space optical set-up in which the positioners are being used to manipulate the two orientation and/or position sensitive optical components, a beam line can be arranged quite close to the breadboard surface. Consequently, other optical components in the set-up can be given short mountings to increase stability.

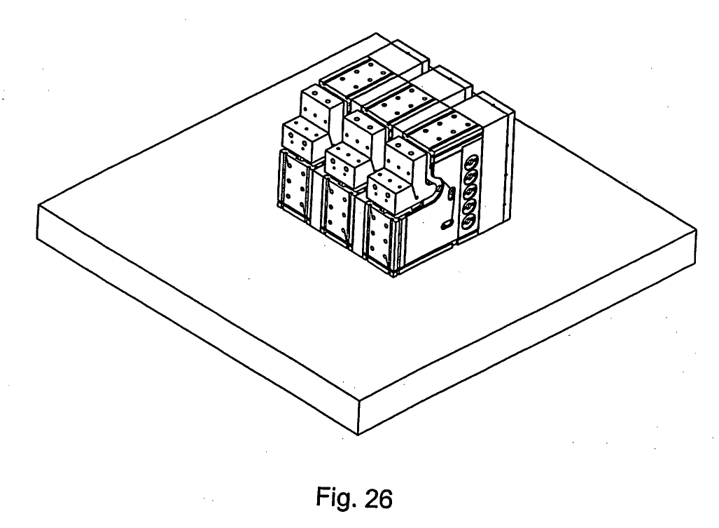

FIG. 26 shows three devices ganged together side-by-side separated by spacers and arranged upright on a breadboard according to a sixth applications example. Long through-bolts (not shown) extend through two or more of the holes 66 and/or 68, and are threaded to nuts (not shown). In addition, spacer plates are arranged between adjacent positioners. The spacers provide greater freedom of movement of the three moving worlds in the y direction. The block of three positioners is then secured to the breadboard using the base plate. This set-up could be used for manipulating three optical components in a common beam line. Another application would be for alignment of a solid-state waveguide with two optical fibres. The solid-state waveguide would be mounted on the middle of the three positioners, with mutually facing optical fibres mounted on the two end positioners.

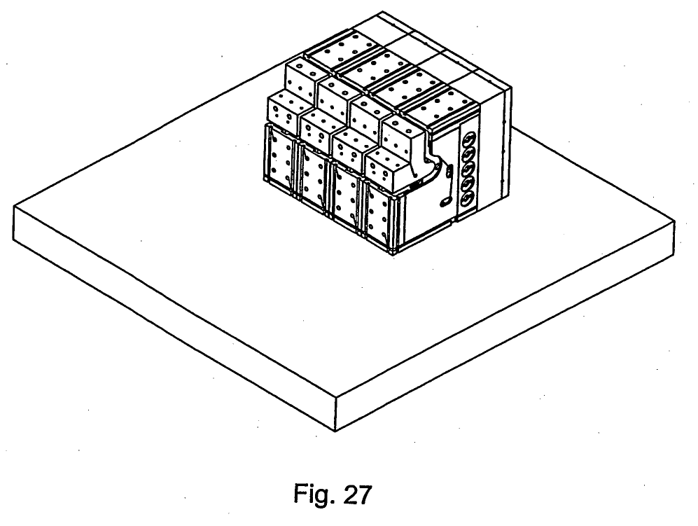

FIG. 27 shows four devices ganged together side-by-side and arranged upright on a breadboard according to a seventh applications example. This is similar to the previous applications example, but with no spacers and four positioners instead of three.

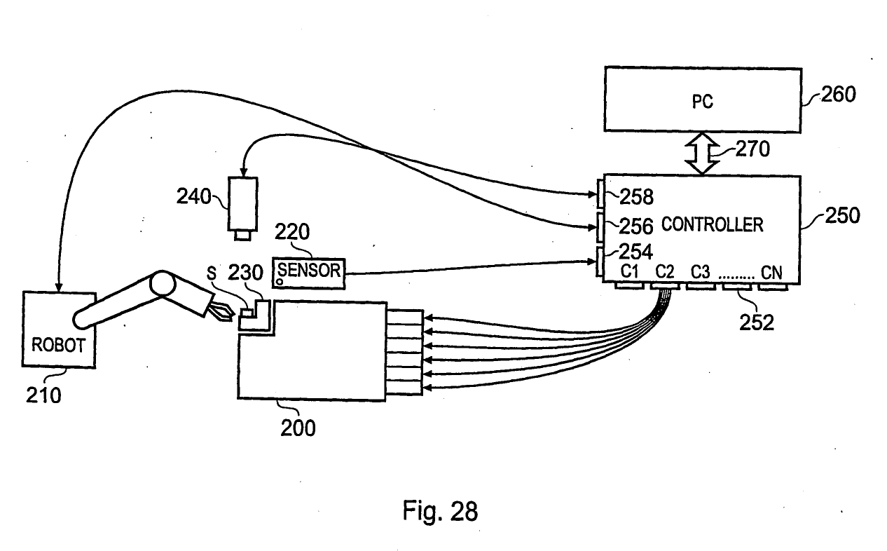

FIG. 28 is a schematic system drawing showing a device according to the invention integrated with a control system and typical components of an automated system employing a positioning device 200 according to the invention. The positioning device 200 includes a moving world 230 for mounting samples S. A sensor 220 is also arranged adjacent to the moving world 230 to measure a parameter relevant to manipulation of the samples S, for example light transmission intensity through an optical fibre. The sensor 220 can be conveniently mounted on the top cover 38 (see FIG. 6) of the positioner. Samples can be arranged on and removed from the moving world 230 by a pick-and-place robot 210 under guidance of a machine vision system including a camera 240. The six motion axes of positioner 200 are driven by six drive control cables from a drive connector C2 of a control unit 250. The control unit is provided with a number of such connectors 252, labelled C1, C2 . . . CN, for driving multiple positioners if desired. The controller also has connectors 256, 254 and 258 for connecting to the robot 210, sensor 220 and camera 240 respectively. The controller 250 is under higher level control by a computer 260 via a suitable interface 270. It will be understood that this schematic generic system is provided merely as a schematic example of a typical system set-up and may be varied as desired. Moreover, it will be understood that the positioning devices can be used without integration into an automated system.

### REFERENCE

[1] EP-A-0937961

1. A multi-axis positioner, comprising:
(a) a fixed part having drive mounts for receiving a plurality of drive inputs;
(b) a movable part having a surface for attaching a sample to be positioned; and
(c) a plurality of drive trains connected between the drive inputs of the fixed part and the movable part, the drive trains being configured to move the movable part relative to the fixed part in a plurality of motion axes responsive to the drive inputs,
wherein the fixed part has a plurality of mounting faces at least two of which are orthogonal to each other to allow the movable part to be arranged in different orientations.

2. A positioner according to claim 1, wherein at least three of the mounting faces are orthogonal to each other.

3. A positioner according to claim 1, wherein at least one pair of the mounting faces are parallel to each other and face in opposite directions.

4. A positioner according to claim 1, wherein at least two pairs of the mounting faces are parallel to each other and face in opposite directions.

5. A positioner according to claim 1, wherein the fixed part has a further face on which all the drive inputs are arranged.

6. A positioner according to claim 5, wherein the drive input face is parallel to, and faces in an opposite direction to, one of the mounting faces.

7. A positioner according to claim 5, wherein the drive input face has an access aperture for each of the drive trains.

8. A positioner according to claim 5, wherein the drive input face has access apertures for only a subset of the drive trains to limit drive inputs to that subset of the drive trains.

9. A positioner according to claim 5 further comprising a piezo drive block attached to the drive input face.

10. A positioner according to claim 5 further comprising a micrometer drive mounting block attached to the drive input face.

11. A positioner according to claim 1, further comprising at least one through hole running from one of the mounting faces through the positioner to allow passage of clamping bolts.

12. A positioner according to claim 1, wherein the movable part is confined to fit within a corner portion of a cuboid defined by six planes which coincide with at least some of the mounting faces.

13. A positioner according to claim 1, wherein the drive trains include linkages which each comprises a rod connected at either end to an end part, each end part being connected to the rod by a joint, wherein the joints allow the linkages to accommodate movement of the other drive trains and the joints are held under compression by resilient biasing elements.

14. A positioner according to claim 1 at least one of the drive trains includes mutually contacting crossed pairs of spigots that can slide and rotate on each other to accommodate movement of the other drive trains.

15. A multi-axis positioner, comprising:
(a) a fixed part having drive mounts for receiving a plurality of drive inputs;
(b) a movable part having a surface for attaching a sample to be positioned;
(c) a plurality of drive trains connected between the drive inputs of the fixed part and the movable part, the drive trains being configured to move the movable part relative to the fixed part in a plurality of motion axes responsive to the drive inputs; wherein the drive trains include linkages which each comprises a rod connected at either end to an end part, each end part being connected to the rod by a joint, wherein the joints allow the linkages to accommodate movement of the other drive trains; and
(d) resilient biasing elements that hold the joints under compression.

16. A positioner according to claim 15, wherein at least some of the joints between the rods and end parts are formed by a pin located on a surface and held under compression.

17. A positioner according to claim 16, wherein the surface is conical to locate the pin at the base of the cone.

18. A positioner according to claim 15, wherein at least some of the joints between the rods and end parts are formed by a ball seated in a socket.

19. A positioner according to claim 15, wherein the compression has a force in the range 1 kgf to 20 kgf, or 2 to 11 kgf so that the linkages are capable of withstanding tension forces exerted along the linkage up to the compression force.

20. A positioner according to claim 15, wherein at least some of the resilient biasing elements form parts of the linkages, being connected under tension between the end parts and their adjacent rods.

21. A positioner according to claim 20, wherein the resilient biasing elements are helical springs and the end parts are provided with a threaded portion having a pitch matched to the pitch of the coils of the helical spring, the end parts being connected to the helical spring by threaded engagement of the threaded portions in the spring coils.

22. A positioner according to claim 21, wherein the threaded portion on the end part is a male thread that is threaded into the inside of the helical spring, or a female thread that is threaded onto the outside of the helical spring.

23. A positioner according to claim 21, wherein the rods are provided with a threaded portion having a pitch matched to the pitch of the coils of the helical spring, the rods being connected to the helical spring by threaded engagement of the threaded portions in the spring coils.

24. A positioner according to claim 23, wherein the threaded portion on the rod is a male thread that is threaded into the inside of the helical spring, or a female thread that is threaded onto the outside of the helical spring.

25. A positioner according to claim 23, wherein the threaded portions on the rods are formed by her helical springs fitted over the rod.

26. A positioner according to claim 15, wherein at least some of the resilient biasing elements are separate from the linkages.

27. A positioner according to claim 15, wherein the fixed part has a plurality of mounting faces at least two of which are orthogonal to each other to allow the movable part to be arranged in different orientations.

28. A positioner according to claim 15, wherein the movable part is confined to fit within a corner portion of a cuboid defined by six planes which coincide with at least some of the mounting faces.

29. A positioner according to claim 15; at least one of the drive trains includes mutually contacting crossed pairs of spigots that can slide and rotate on each other to accommodate movement of the other drive trains.

30. A multi-axis positioner, comprising:
(a) a fixed part having drive mounts for receiving a plurality of drive inputs;
(b) a movable part having a surface for attaching a sample to be positioned; and
(c) a plurality of drive trains connected between the drive inputs of the fixed part and the movable part, the drive trains being configured to move the movable part relative to the fixed part in a plurality of motion axes responsive to the drive inputs, wherein
at least one of the drive trains includes mutually contacting crossed pairs of spigots that can slide and rotate on each other to accommodate movement of the other drive trains.

31. A positioner according to claim 30, wherein at least one of each crossed pair of spigots is arcuate in cross-section.

32. A positioner according to claim 30, wherein the crossed pairs of spigots contact each other tangentially.

33. A positioner according to claim 30, wherein the crossed pairs of spigots are maintained in contact with each other by a resilient biasing element arranged to exert a pulling force on one of the spigots towards the other.

34. A positioner according to any one of claim 30, wherein the at least one of the drive trains includes at least one linkage comprising a rod connected at either end to an end part, each end part being connected to the rod by a joint, wherein the joint allows each linkage to accommodate movement of the other drive train.

35. A positioner according to claim 30, wherein the at least one of the drive trains includes a flexure to constrain motion of the movable part induced by actuation of the at least one of the drive trains to the motion axis concerned.

36. A positioner according to claim 30, wherein the at least one linkage includes a first linkage that is connected between the fixed part and a crank to which one of a crossed pair of spigots is attached.

37. A positioner according to claim 36, wherein the at least one linkage includes a second linkage that is connected between the movable part and an intermediate part to which the other one of the crossed pair of spigots is attached.

38. A positioner according to claim 36, wherein the other one of the crossed pairs of spigots is attached to the movable part.

39. A positioner according to claim 30, the fixed part has a plurality of mounting faces at least two of which are orthogonal to each other to allow the movable part to be arranged in different orientations.

40. A positioner according to claim 30, wherein the movable part is confined to fit within a corner portion of a cuboid defined by six planes which coincide with at least some of the mounting faces.

41. A positioner according to claim 30, wherein the drive trains include linkages which each comprises a rod connected at either end to an end part, each end part being connected to the rod by a joint, wherein the joints allow the linkages to accommodate movement of the other drive trains and the joints are held under compression by resilient biasing elements.

42. A multi-axis positioner, comprising:
(a) a fixed part having drive mounts for receiving a plurality of drive inputs;
(b) a movable part having at least one sample attachment surface for attaching a sample to be positioned; and
(c) a plurality of drive trains connected between the drive inputs of the fixed part and the movable part, the drive trains being configured to move the movable part relative to the fixed part in a plurality of motion axes responsive to the drive inputs,
wherein the movable part is confined to fit within a corner portion of a cuboid defined by six planes which coincide with at least some of the mounting faces, so that the movable part has four sides facing externally and two sides facing internally, wherein the drive trains access the movable part from the two internally facing sides only.

43. A positioner according to claim 42, wherein the movable part is actuated by three flexible linkages extending into a downwardly facing one of the internally facing sides to control z, pitch and roll motion.

44. A positioner according to claim 42, wherein the movable part is actuated by two flexible linkages extending into a sideways facing one of the internally facing sides to control x and yaw motion.

45. A positioner according to claim 42, wherein the movable part is actuated by mutually contacting crossed pairs of spigots, one of which is attached to the movable part, to control y motion.

46. A positioner according to claim 42, wherein there are drive trains for providing at least 3, 4 or 5 of x, y, z, pitch, roll and yaw motion.

47. A positioner according to claim 42, wherein the at least one sample attachment surface includes four sample attachment surfaces aligned with the four externally facing sides of the movable part.

48. A positioner according to claim 42, wherein the movable part is L-shaped in cross-section to provide two externally facing sample attachment surfaces that extend parallel to the internally facing sides.

49. A positioner according to claim 42, wherein the fixed part has a plurality of mounting faces at least two of which are orthogonal to each other to allow the movable part to be arranged in different orientations.

50. A positioner according to claim 42 wherein the drive trains include linkages which each comprises a rod connected at either end to an end part, each end part being connected to the rod by a joint, wherein the joints allow the linkages to accommodate movement of the other drive trains and the joints are held under compression by resilient biasing elements.

51. A positioner according to claim 42, at least one of the drive trains includes mutually contacting crossed pairs of spigots that can slide and rotate on each other to accommodate movement of the other drive trains.
